(19) United States
(12) Patent Application Publication
(10) Pub. No.: US 2008/0285937 A1
(43) Pub. Date: Nov. 20, 2008

(54) Video/audio display system and method

(75) Inventors: Chin-Fang Lee, Tainan County (TW); Ming-Te Chou, Keelung City (TW)

Correspondence Address: BIRCH STEWART KOLASCH & BIRCH, PO BOX 747, FALLS CHURCH, VA, 22040-0747, US

(73) Assignees: Accton Technology Corporation; Arcadyan Technology Corporation

(21) Appl. No.: 11/898,153

(22) Filed: Sep. 10, 2007

(30) Foreign Application Priority Data
May 14, 2007 (TW) 096117097

(51) Int. Cl. H04N 5/91

(52) U.S. Cl. 386/46

(57) ABSTRACT

A video/audio display system includes a buffering module, a playing module and a controlling module. The buffering module temporarily stores video/audio data, which occupy a storage capacity of the buffering module. The playing module is electrically connected with the buffering module to play the video/audio data at a playing speed. The controlling module is electrically connected with the buffering module and the play module. A video/audio display method is also disclosed.

### BACKGROUND OF THE INVENTION

1. Field of Invention

The invention relates to a display system and method and, in particular, to a video/audio display system and method.

2. Related Art

In the information and multimedia era, video/audio display systems have become an indispensable part of human life, providing various information and entertainments to users.

A conventional video/audio display system 1 comprises a host 11 and a client 12. The host 11 stores video/audio data V₀. The client 12 has at least a buffer memory 121 and a player 122. The client 12 first downloads the video/audio data V₀ in real time from the host 11 via a network NET, and stores the video/audio data V₀ temporarily in the buffer memory 121. Once the size of the video/audio data V₀ in the buffer memory 121 exceeds a predetermined value, the player 122 starts playing the stored video/audio data V₀.

However, generally speaking, the download speed of the network NET is often affected by the network environment and is unstable, and may be slow, be delayed, or even be interrupted. The accumulation speed of video/audio data V₀ in the buffer memory 121 is slower than the playing speed of the same video/audio data V₀ in the player 122. In other words, the buffer memory 121 often cannot immediately provide sufficient video/audio data V₀ for the player 122 to play. This results in interruptions in the played video/audio data V₀, lowering the playing quality.

The service provider can provide a buffer memory with a higher storage capacity to reduce the possibility of interruptions due to network instability. Nonetheless, this inevitably increases the cost of service products.

Therefore, it is an important subject to provide a video/audio display system with a stable playing quality and a method thereof.

### SUMMARY OF THE INVENTION

In view of the foregoing, the invention is to provide a video/audio display system with a stable playing quality and a method thereof.

To achieve the above, the invention discloses a video/audio display system, which includes a buffering module, a playing module, and a controlling module. The buffering module temporarily stores video/audio data occupying a storage capacity of the buffering module. The playing module, which is electrically connected with the buffering module, plays the video/audio data at a playing speed. The controlling module, which is electrically connected with the buffering module and the playing module, controls the playing speed according to the amount of storage capacity.

To achieve the above, the invention discloses a video/audio display method, which is implemented with a buffering module and a playing module. The method includes the following steps of: temporarily storing video/audio data in the buffering module, wherein the video/audio data occupies a storage capacity of the buffering module; playing the video/audio data at a playing speed via the playing module; and controlling the playing speed according to the amount of the storage capacity.

As mentioned above, the disclosed video/audio display system and the method thereof controls the playing speed of the playing module according to the amount of the storage capacity occupied by the video/audio data. Therefore, the disclosed video/audio display system and the method thereof can automatically control the playing speed in response to the amount of video/audio data temporarily held in the buffering module. For example, when the speed at which the video/audio display system is retrieving the video/audio data from an external source is below the playing speed at which the playing module is playing the temporarily stored video/audio data, the storage capacity occupied by the video/audio data decreases. The controlling module then lowers the playing speed so that the video/audio data played thereby is not likely to be interrupted, ensuring the playing quality.

Furthermore, the disclosed video/audio display system controls the playing speed of the playing module according to the amount of storage capacity occupied by the video/audio data. Therefore, unlike the prior art, there is no need to purchase a buffering memory with a high storage capacity. The product cost of the invention can thus be lowered.

### BRIEF DESCRIPTION OF THE DRAWINGS

The invention will become more fully understood from the detailed description given herein below illustration only, and thus is not limitative of the present invention, and wherein:

FIG. 1 is a block diagram of the conventional video/audio display system;

FIGS. 2 and 3 are block diagrams of the video/audio display system according to the first embodiment of the invention;

FIG. 4 is a block diagram of the video/audio display system according to the first embodiment of the invention; and

FIG. 5 is a flowchart of the video/audio display method according to the preferred embodiment of the invention.

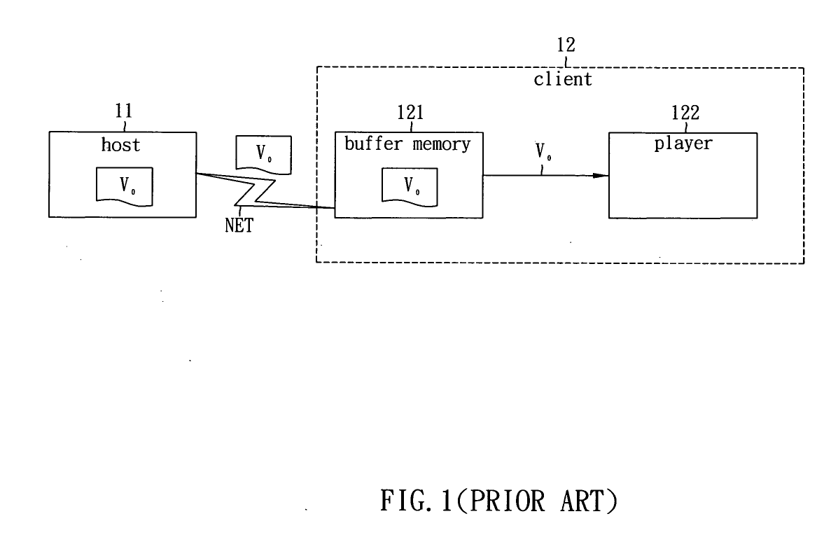

### DETAILED DESCRIPTION OF THE INVENTION

The present invention will be apparent from the following detailed description, which proceeds with reference to the accompanying drawings, wherein the same references relate to the same elements.

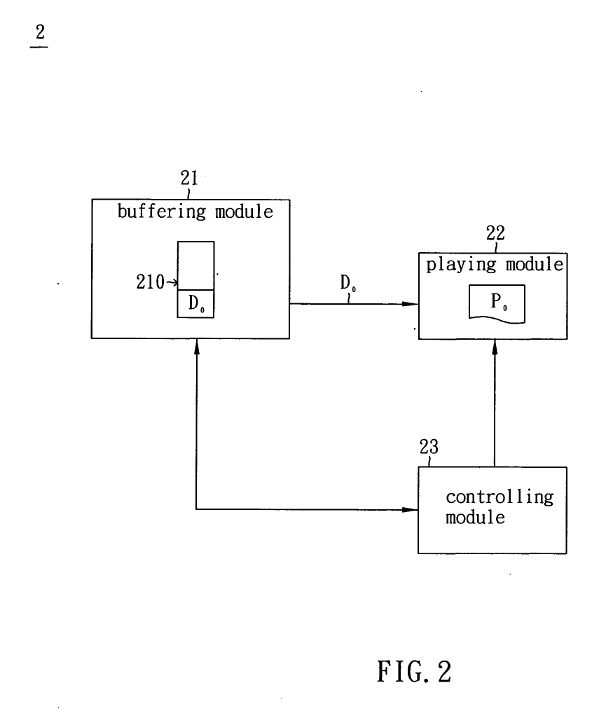

As shown in FIG. 2, the video/audio display system 2 according to a preferred embodiment of the invention includes a buffering module 21, a playing module 22, and a controlling module 23.

The buffering module 21 has at least a memory 210 for temporarily storing video/audio data D₀. The video/audio data D₀ occupy a storage capacity of the memory 210 in the buffering module 21. For example, when the memory 210 of the buffering module 21 has 1 MB of capacity to hold the video/audio data D₀, then the storage capacity occupied by the video/audio data D₀ is 1 MB. Additionally, the buffering module 21 can be designed according to the prior art to be a first input first output (FIFO) buffering module. The details are not further described herein.

The playing module 22 is electrically connected with the buffering module and plays the temporarily stored video/audio data D₀ at a playing speed P₀.

The controlling module 23 is electrically connected with the buffering module 21 and the playing module 22, and controls the playing speed P₀ of the playing module 22 according to the size of storage capacity occupied by the video/audio data D₀ in the memory 210.

In this embodiment, the controlling module 23 can control the playing speed P₀ according to the amount of the storage capacity occupied by the video/audio data D₎ in the memory 210. For example, if the storage capacity occupied by the video/audio data D₀ in the memory 210 is a first value, the controlling module 23 regulates the playing speed P₀ to a first speed. When the storage capacity occupied by the video/audio data D₀ in the memory 210 is a second value, the controlling module 23 regulates the playing speed P₀ to a second speed. If the second value is larger than the first value, the second speed is faster than the first speed.

In other words, if the speed of retrieving external video/audio data D₀ by the video/audio display system 2 is lower than the playing speed P₀ of the playing module 22 for playing the temporarily held video/audio data D₀ so that the storage capacity occupied by the video/audio data D₀ in the memory 210 is decreasing, the controlling module 23 can reduce the playing speed P₀ of the playing module 22. Therefore, the video/audio data D₀ played by the playing module 22 are not likely to be interrupted, ensuring the playing quality thereof.

The relation between the value of the storage capacity occupied by the video/audio data D₀ in the memory 210 and the playing speed P₀ can be computed in real time using a processor. The correspondence relation can be stored in advance in some memory for the controlling module 23 to use.

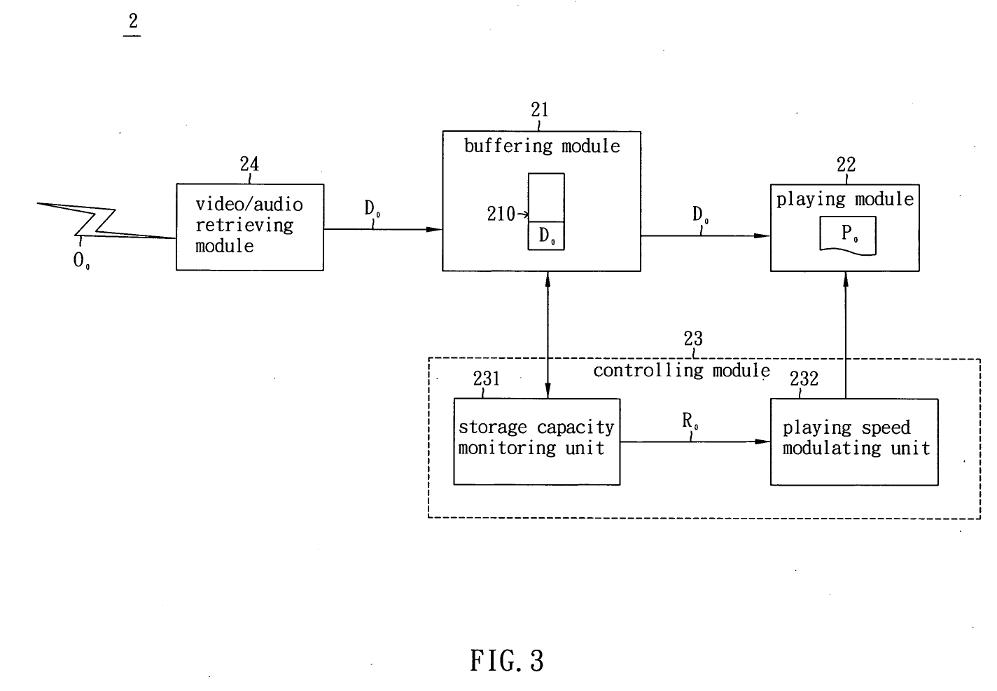

Furthermore, as shown in FIG. 3, the controlling module 23 includes a storage capacity monitoring unit 231 and a playing speed modulating unit 232.

The storage capacity monitoring unit 231 is electrically connected with the buffering module 21 to monitor the amount of storage capacity occupied by the video/audio data D₀ in the memory 210 and generate a monitoring result R₀. The playing speed modulating unit 232 is electrically connected with the storage capacity monitoring unit 231 and the playing module 22 to control the playing speed P₀ according to monitoring result R₀.

Moreover, the video/audio display system 2 also includes a video/audio retrieving module 24 electrically connected with the buffering module 21. The video/audio retrieving module 24 retrieves the video/audio data D₀ from an external source O₀, and transfers them to the buffering module 21. In this embodiment, the external source O₀ is a network. In this case, suppose the transmission speed between the video/audio playing system 2 and the external source O₀ is affected by the environment and becomes unstable, slower, delayed or even interrupted. The speed of the buffering module 21 temporarily storing the video/audio data D₀ is lower than the playing speed P₀ of the playing module 22 playing the temporarily stored video/audio data D₀, such that the storage capacity occupied by the video/audio data D₀ in the memory 210 decreases. The controlling module 23 can reduce the playing speed P₀ of the playing module 22. Therefore, the video/audio data D₀ played by the playing module 22 are not likely to be interrupted, ensuring the quality of play.

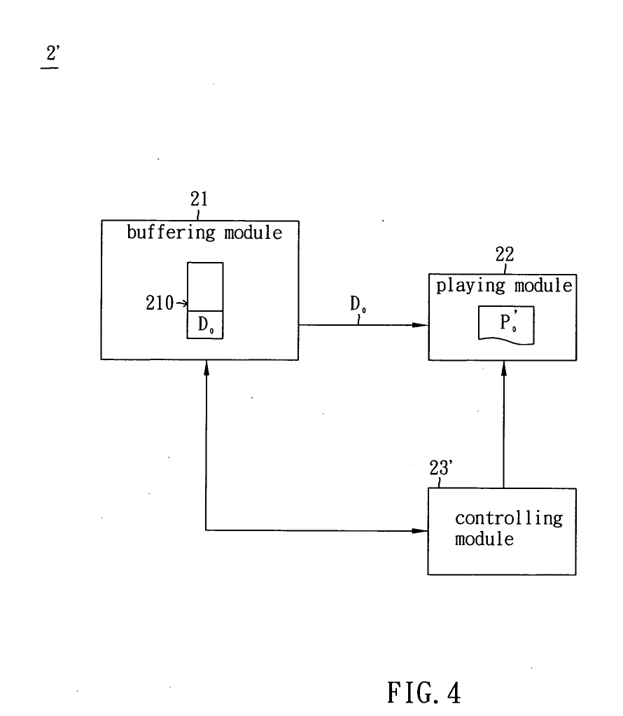

With reference to FIG. 4, the video/audio display system 2′ according to a second embodiment of the invention includes at least a buffering module 21, a playing module 22, and a controlling module 23′. The difference between the current embodiment and the first embodiment is in that: the controlling module 23′ can compare the storage capacity occupied by the video/audio data D₀ in the memory 210 with a threshold value to control the playing speed P₀′. For example, if the storage capacity is smaller than the threshold value, the controlling module 23 controls the playing speed P₀′ at a first speed. When the storage capacity occupied by the video/audio data D₀ in the memory 210 is larger than the threshold value, the controlling module 23′ controls the playing speed P₀′ at a second speed. The second speed is faster than the first speed.

When the speed at which the video/audio display system 2′ is retrieving the video/audio data D0 from an external source lags behind the playing speed P0′ at which the playing module 22 is playing the temporarily stored video/audio data D0 such that the storage capacity occupied by the video/audio data D0 in the memory 210 is below the threshold value, the controlling module 23′ can reduce the playing speed P0′. The video/audio data D0 played by the playing module 22 is thus not likely to be interrupted. When the storage capacity occupied by the video/audio data D0 in the memory 210 is above the threshold value, the controlling module 23′ controls the playing module 22 to play the temporarily stored video/audio data D0 in real time at a normal speed P0′.

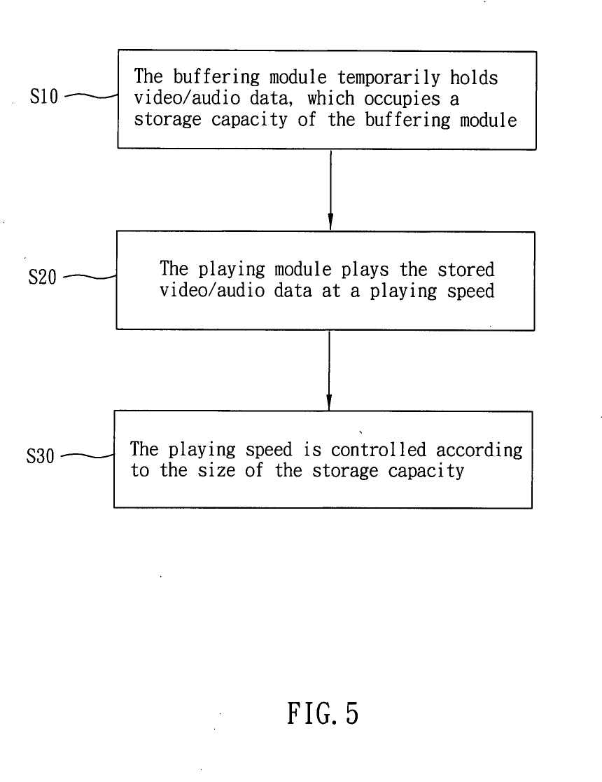

FIG. 5 shows a video/audio display method according to a preferred embodiment of the invention. It is implemented in conjunction with a buffering module and a playing module. The video/audio display method includes steps S10˜S30.

In step S10, the buffering module temporarily holds video/audio data, which occupies a storage capacity of the buffering module.

In step S20, the playing module plays the stored video/audio data at a playing speed.

In step S30, the playing speed is controlled according to the size of the storage capacity.

The video/audio display method of the embodiment has been detailed using the video/audio display system 2, 2′ disclosed in the first and second embodiments before (FIGS. 2˜4). Therefore, the detailed descriptions are omitted here.

In summary, the disclosed video/audio display system and the method thereof controls the playing speed of the playing module according to the amount of the storage capacity occupied by the video/audio data. Therefore, the disclosed video/audio display system and the method thereof can automatically control the playing speed in response to the amount of video/audio data temporarily held in the buffering module. For example, when the speed at which the video/audio display system is retrieving the video/audio data from an external source is below the playing speed at which the playing module is playing the temporarily stored video/audio data, the storage capacity occupied by the video/audio data decreases. The controlling module then lowers the playing speed so that the video/audio data played thereby is not likely to be interrupted, ensuring the playing quality.

Furthermore, the disclosed video/audio display system controls the playing speed of the playing module according to the amount of storage capacity occupied by the video/audio data. Therefore, unlike the prior art, there is no need to purchase a buffering memory with a high storage capacity. The product cost of the invention can thus be lowered.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A video/audio display system, comprising:
a buffering module, which temporarily stores video/audio data occupying a storage capacity thereof;
a playing module, which is electrically connected with the buffering module and plays the video/audio data at a playing speed; and
a controlling module, which is electrically connected with the buffering module and the playing module to control the playing speed according to the amount of storage capacity.

2. The video/audio display system of claim 1, wherein the controlling module regulates the playing speed to a first speed when the storage capacity is a first value.

3. The video/audio display system of claim 2, wherein the controlling module regulates the playing speed to a second speed when the storage capacity is a second value.

4. The video/audio display system of claim 3, wherein the second speed is larger than the first speed when the second value is larger than the first value.

5. The video/audio display system of claim 1, wherein the controlling module controls the playing speed at a first speed when the storage capacity is smaller than a threshold value and at a second speed when the storage capacity is greater than the threshold value.

6. The video/audio display system of claim 5, wherein the second speed is larger than the first speed.

7. The video/audio display system of claim 1, wherein the controlling module further includes:
a storage capacity monitoring unit, which is electrically connected with the buffering module to monitor the size of the storage capacity and generate a monitoring result; and
a playing speed modulating unit, which is electrically connected with the storage capacity monitoring unit and the playing module to control the playing speed according to the monitoring result.

8. The video/audio display system of claim 1 further comprising:
a video/audio retrieving module, which is electrically connected with the buffering module for retrieving the video/audio data from an external source and transferring the video/audio data to the buffering module.

9. The video/audio display system of claim 8, wherein the external source is a network.

10. A video/audio display method implemented with a buffering module and a playing module, the method comprising the steps of:
temporarily storing video/audio data in the buffering module, wherein the video/audio data occupies a storage capacity of the buffering module;
playing the video/audio data at a playing speed via the playing module; and
controlling the playing speed according to the amount of the storage capacity.

11. The method of claim 10, wherein the controlling module regulates the playing speed to a first speed when the storage capacity is a first value.

12. The method of claim 11, wherein the controlling module regulates the playing speed to a second speed when the storage capacity is a second value.

13. The method of claim 12, wherein the second speed is larger than the first speed when the second value is larger than the first value.

14. The method of claim 10, wherein the playing speed is at a first speed when the storage capacity is smaller than a threshold value and at a second speed when the storage capacity is greater than the threshold value.

15. The method of claim 14, wherein the second speed is larger than the first speed.

16. The method of claim 10, wherein the step of controlling the playing speed according to the size of the storage capacity comprises the steps of:
monitoring the amount of the storage capacity to generate a monitoring result; and
controlling the playing speed according to the monitoring result.

17. The method of claim 10 further comprising the step of:
retrieving the video/audio data from an external source.

18. The method of claim 17, wherein the external source is a network.
